(19) United States
(12) Patent Application Publication
(10) Pub. No.: US 2026/0211451 A1
(43) Pub. Date: Jul. 23, 2026

(54) ELECTRONIC DEVICE

(71) Applicant: Apple Inc., Cupertino, CA (US)

(72) Inventors: Ibuki Kamei, Santa Clara, CA (US); Cameron A Harder, San Francisco, CA (US); Rick Y Huang, Sunnyvale, CA (US)

(21) Appl. No.: 19/356,573

(22) Filed: Oct. 13, 2025

Related U.S. Application Data
(60) Provisional application No. 63/747,263, filed on Jan. 20, 2025.

(51) Int. Cl. G06F 1/16

(52) U.S. Cl. CPC G06F 1/163

(57) ABSTRACT

A wearable display device can include a display frame, a hinge coupled to the display frame, and an arm movably coupled to the hinge. The arm can extend distally from the display frame and be movable relative to the display frame via the hinge. The wearable display device can further include a first electrical connector disposed on the distal end of the arm and another arm defining an internal volume, which can receive at least a portion of the first arm to removably couple to the other arm. The device can further include an electrical connector assembly disposed within the internal volume. The electrical connector assembly can include a multi-layer board (MLB), and an electrical connector disposed proximal to the MLB.

### CROSS-REFERENCE TO RELATED APPLICATIONS

This application claims the benefit of U.S. Provisional Application No. 63/747,263, filed 20 January 2025, entitled “ELECTRONIC DEVICE,” the entire disclosure of which is hereby incorporated by reference.

### FIELD

The present disclosure relates generally to electronic devices. More particularly, the present disclosure relates to arms for a wearable electronic device.

### BACKGROUND

Various components of head-mountable devices (HMD) or wearable electronic devices, such as display screens, viewing frames, securement arms, speakers, batteries, waveguides, and other components operate together to provide an immersive experience. Current HMDs include components disposed within various locations of the HMD such as in the display frame and the securement arms, making interchangeability of components difficult. Consequently, current HMDs do not offer features to upgrade or interchange the components of the HMD as the new components are released to users or as different components are desired based on the type of use. Consequently, the user may need to purchase a new HMD that includes the new components. Therefore, there is a need for an HMD that includes components that can be interchanged without replacing the whole HMD.

### SUMMARY

A wearable display device can include a display frame, a hinge coupled to the display frame, and a first arm movably coupled to the hinge. The first arm can extend distally from the display frame, and the first arm can be movable relative to the display frame via the hinge. The wearable display device can further include a first electrical connector disposed on the distal end of the first arm and a second arm defining an internal volume to receive at least a portion of the first arm to removably couple to the first arm. The device can further include an electrical assembly disposed within the internal volume. The electrical connector assembly can include a multi-layer board (MLB), and the first electrical connector disposed proximal to the MLB and the second electrical connector can be electrically coupled with the first electrical connector.

In one example, the hinge can rotate the first arm relative to the display frame about an axis. The first arm received by the second arm can form a seamless arm. In one example, the first arm can include a seal disposed around the distal end of the first arm, and the seal can be a hermetic seal. In one example, the distal end of the first arm can define at least one aperture and the proximal end of the second arm can define an opening aligned with the aperture when the second arm is secured to the first arm. In this example, the device can further include at least one fastener disposed through the opening of the second arm and the aperture of the first arm to fasten the first arm to the second arm. In some examples, the fastener can be a screw. The device can further include a camera disposed within the display frame, and the camera can be electrically coupled to the first electrical connector. In one example, the first electrical connector and the second electrical connector include at least one of a pin electrical connector or a slot electrical connector.

In one example of the present disclosure, a head-mountable display (HMD) can include a display frame, a first electrical connector secured to the display frame, and a first arm removably coupled to the display frame and extending distally from the display frame. The HMD can further include a second electrical connector coupled to a distal end of the first arm and the second electrical connector can be electrically coupled to the first electrical connector. In one example, the HMD includes a hinge coupled to a distal end of the first arm, and a second arm coupled to the first arm via the hinge, wherein the second arm can be movable relative to the first arm via the hinge.

In one example, the second electrical connector can include a housing coupled to the distal end of the first arm. The HMD can further include a camera coupled to the housing and the display frame can define an aperture that the camera can extend through. In this way, the camera can be electrically coupled to the second electrical connector.

In one example of the present disclosure, a wearable electronic device can include a display frame defining an aperture, a first electrical connector coupled to the display frame, and an electrical connector assembly. The electrical connector assembly can include a housing, the housing including a proximal end removably coupled to the display frame, and a distal end. The electrical connector can further include a second electrical connector disposed on the proximal end of the housing; the second electrical connector can be electrically coupled to the first electrical connector. The wearable electronic device can also include a camera coupled to the housing; the camera can be disposed within the aperture. The wearable electronic device can further include a first arm coupled to the distal end of the housing, a hinge coupled to a distal end of the first arm, and a second arm coupled to the first arm via the hinge.

In one example, the second arm can be movable relative to the first arm about an axis via the hinge. In one example, the second electrical connector can be electrically coupled to the first electrical connector via a blind mate connection.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a top view of a wearable display device;

FIG. 2A illustrates a rear isometric view of a wearable display device;

FIG. 2B illustrates an exploded view of a wearable display device;

FIG. 3 illustrates a top view of one example of a wearable display device;

FIG. 4 illustrates a top view of one example of a wearable display device; and

FIG. 5 illustrates a top view of one example of a wearable display device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure generally relates to electronic devices. More particularly, the present disclosure relates to head-mountable electronic devices. Current head-mountable devices (HMD) include components such as display screens, viewing frames, securement arms or bands, speakers, batteries, waveguides, and other components that operate together to provide an immersive experience. Current HMDs include those components within various portions and housings of the HMD, such as in the display frame and the securement arms. These components can be electrically coupled together and can be disposed about the HMD such that the components cannot be interchanged. As technology advances, or as users desire personalized and/or upgraded components, current devices can fall behind.

In one example, a user may want or need personalized securement arms for unique head sizes and shapes. In another example, a user may want one set of securement arms or bands for exercise applications and another set for movie watching. In one example, upgradable components can include batteries with a longer cycle life, upgraded processors, projectors, or any other updated component. Consequently, current HMDs do not enable easy interchangeability of these components. Instead, a user may have to purchase a new HMD that includes these new components to enhance the immersive experience of the HMD. Purchasing entirely new headsets when sub-components need to be replaced is expensive and leads to electronic waste. Therefore, the HMD or wearable display devices described herein enable the components of the HMD to be easily customized, swapped out, or upgraded.

In one example of the present disclosure, a wearable display device or HMD can include a display frame, a hinge coupled to the display frame, and a first arm movably coupled to the hinge. In one example, the first arm can rotate relative to the display frame about an axis via the hinge. In this example, the arms of the wearable device can be rotated into a storage position. For example, the arms of the exemplary device can be moved into a storage position to fit into a storage case.

The device can further include a first electrical connector disposed on the distal end of the first arm, along with a second arm defining an internal volume. In one example, the second arm can receive at least a portion of the first arm in the internal volume to removably couple to the first arm. In this way, the first arm joined with the second arm can form a single, seamless arm. The seamless arm design can be aesthetically pleasing to a user. The wearable display device can further include an electrical assembly disposed within the internal volume of the second arm. The electrical assembly can include a multi-layer board (MLB), and an electrical connector disposed proximal to the MLB. In some examples the electrical connector disposed proximal to the MLB can be electrically coupled to the first electrical connector.

In one example of the present disclosure, a wearable electronic device can include a display frame defining an aperture, a first electrical connector coupled to the display frame, and an electrical connector assembly. The electrical connector assembly can include a housing having a proximal end removably coupled to the display frame at a distal end. The electrical connector can further include a second electrical connector disposed on the proximal end of the housing such that the second electrical connector can be electrically coupled to the first electrical connector. In one example, the electrical connector can include a camera coupled to the housing. In one example, the camera can be disposed within the aperture defined by the display frame. The camera can be oriented such that the device can include an outward facing camera secured to the display frame. Furthermore, the camera can be replaced along with the securement arm without replacing the display frames. In this example, the wearable electronic device can further include a first arm coupled to the distal end of the housing, a hinge coupled to a distal end of the first arm, and a second arm coupled to the first arm via the hinge. In one example, the second arm can be movable about an axis relative to the first arm via the hinge.

In the above-mentioned examples, the display frame can include few electronic components as the electronic components can be disposed in the securement arms. In one example, the display frame can include electrical wiring to connect the left securement arm to the right securement arm when attached to the frame. In this example, the securement arms of the device (e.g., the second arm) can include other components for use such as batteries, projectors, speakers, or any other desired functional components. In this way, the user can swap out the securement arms for other securement arms or as upgraded components are released to the user, eliminating the need for the user to upgrade the display portion of the HMD. Consequently, the design of the device can enable the user to interchange the securement arm of the device to increase customization, reduce costs, and improve the user’s immersive experience.

In one example, the frame of the wearable electronic device can be free of electronics. In this way, the securement arms of the device can include all components of the HMD. Therefore, the user can have custom frames or prescription lenses installed into the frames without needing to replace the frames or the prescription lenses when upgrading components of the HMD. In this example, the securement arms can be secured to the display frame and can be communicatively coupled (e.g., via Bluetooth or another wireless connection) such that the frame can include no electronic components.

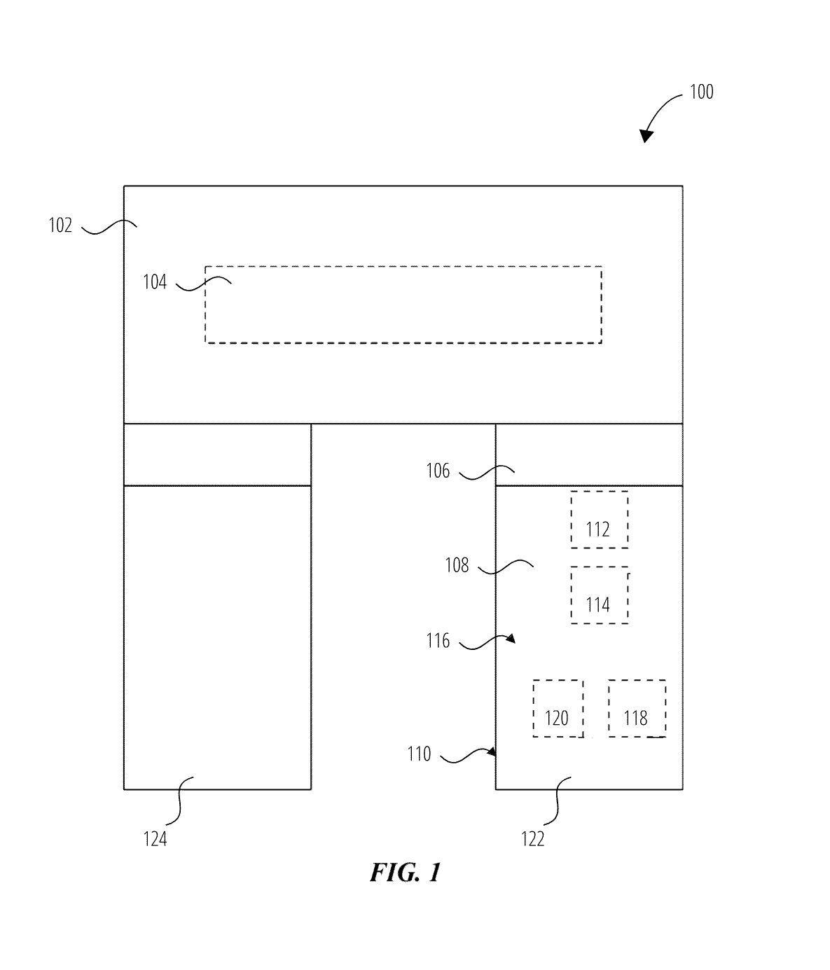

These and other embodiments are discussed below with reference to FIGS. 1-5. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates the top view of a wearable display device 100. The wearable display device 100 can be a head-mountable device (HMD) or can be any device or system configured to be worn on the head of a user, such as an optical device, smart glasses, alternate/virtual reality goggles, and the like. As illustrated in FIG. 1, the wearable display device 100 can include at least one display frame 102, which can house a variety of components and systems. In one example, the display frame 102 can be configured to secure one or more display windows 104 configured to present visual information to the user. In one example of the present disclosure, the display windows 104 can include optically transparent display windows, display screens, transparent material, optical lenses, transparent display screens, or combinations thereof, in front of the eyes of the user. The wearable display device 100 can include a hinge 106 coupled to the display frame 102. The wearable display device 100 can further include at least one securement arm 108. The securement arm 108 can movably couple to the hinge 106 and the securement arm 108 can extend from the display frame 102. The securement arm 108 can be movable relative to the display frame 102 via the hinge 106. In this way, the securement arm 108 of the wearable display device 100 can be folded in, for example, such as the arms of eyeglasses or spectacles when they are folded into a closed position (e.g., stow position). In one example, the securement arm 108 can be a single securement arm, plurality of securement arms, a flexible band, or the like.

As illustrated in FIG. 1, the wearable display device 100 can include a first securement arm 122 and a second securement arm 124. In one example, the first securement arm 122 and the second securement arm 124 can curve downward to comfortably fit behind the user's ears. In one example, the distal end 110 of the securement arm 108 can be a flexible material such that the user can adjust the curvature of the securement arm 108 to increase the comfort as the user dons the wearable display device 100. In this way, the wearable display device 100 can be donned by users with a variety of head sizes such that the wearable display device 100 can be comfortable for any suitable size or shape head for the duration of use.

In one example, the securement arm 108 can define an internal volume 116 and can house a variety of different components. These components can include, for example, a projector 112. The projector 112 can be disposed within the internal volume 116 of the securement arm 108. The projector 112 can be configured to direct light displayed at the display windows 104 attached to the display frame 102. The securement arm 108 can, in some examples, further include a battery 114, a microphone 118, a speaker 120, and/or any other suitable electrical components. As illustrated in FIG. 1, the components can be disposed in one securement arm 108, in both the first securement arm 122 and the second securement arm 124, and/or any other combination not illustrated in FIG. 1.

In one example, the display frame 102 can include optically transparent display windows, optical prescription lenses, or the like. In this example, all electrical components can be disposed within the internal volume 116 of the securement arms 108. In some examples, the securement arms 108 can be removably coupled to the display frame 102 such that the securement arms 108 can be interchangeable. According to this example, the display frame 102 can include electrical wiring to electrically couple the first securement arm 122 and the second securement arm 124 through the display frame 102. In this way, the first securement arm 122 can be removably coupled and electrically coupled to the display frame 102 and to the second securement arm 124. Consequently, according to this example, the user can have a customizable display frame 102 that can include prescription optical lenses, and the user can interchange the first securement arm 122 and the second securement arm 124 of the wearable display device 100 to suit their needs for varying conditions and functionality. Thereby, the user need only replace securement arms 108 to upgrade or replace components within the wearable display device 100.

In another example, the display frame 102 can be void of any functional electronic components. For example, the display frame 102 can include no electrical components and no electrical wiring, such that the display frame 102 can be a purely mechanical frame. In this example, the first securement arm 122 and the second securement arm 124 can be coupled to the display frame 102 and can communicatively couple to each other via a wireless transmission protocol (e.g., via Bluetooth, Wi-Fi, or any other suitable method). In this example, the first securement arm 122 and the second securement arm 124 can each include an antenna (not illustrated) to be communicatively coupled to each other. In this way, the display frame 102 can be a mechanical frame and all electrical components of the wearable display device 100 can be housed within the securement arm 108. It should be understood the electrical components (e.g., processor, batteries, antennas, or any other suitable electronic components) can be housed within one securement arm 108, both securement arms 108, and any other suitable combination. This configuration allows the user to update or replace the electrical components of the wearable display device 100 by interchanging the securement arms 108.

Any of the features, components, and/or parts, of the electronic device, including the arrangements and configurations thereof shown in FIG. 1, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

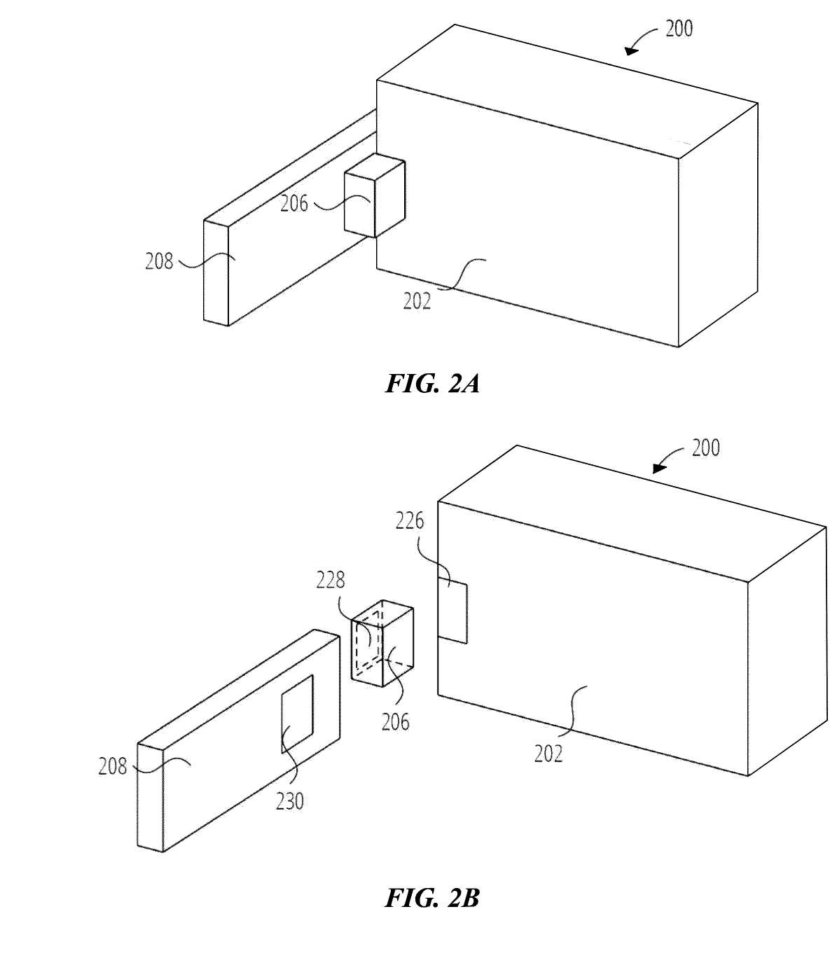

FIG. 2A through FIG. 5 illustrate examples of an HMD that resemble the wearable display device described above in FIG. 1 in certain respects. For example, FIG. 2A illustrates a wearable display device 200 that can include similar features of the wearable display device 100 of FIG. 1. Relevant disclosure set forth above regarding similarly identified features thus may not be repeated hereafter. Moreover, specific features of the wearable display device and related components of FIG. 1 may not be shown or identified by reference numeral in the drawings or specifically discussed in the written description that follows. However, such features may be the same, or substantially the same, as features depicted in other embodiments and/or described with respect to such embodiments. Accordingly, the relevant descriptions of such features apply equally to the features of the wearable display device, HMD, and related components depicted in FIG. 2A through FIG. 5.

FIG. 2A illustrates a rear isometric view of a wearable display device 200. The wearable display device 200 can include a display frame 202, a hinge 206 coupled to the display frame 202, and a securement arm 208 movably coupled to the hinge 206 and extending from the display frame 202. FIG. 2B illustrates an exploded view of the wearable display device 200 shown in FIG. 2A. As illustrated in FIG. 2B, the display frame 202 can define a securement port 226 configured to receive the hinge 206. In one example, the securement port 226 can be an electrical port to electrically couple to the hinge 206 to the display frame 202.

As illustrated in FIG. 2B, the hinge 206 can include a first electrical connector 228, and the securement arm 208 can include a second electrical connector 230. In this example, the first electrical connector 228 can be electrically coupled to the second electrical connector 230. In one example, the first electrical connector 228 and the second electrical connector 230 can be a power interface, a data interface, and/or a power and data interface. In this way, power and data can be selectively transferred between the hinge 206, the securement arm 208, the display frame 202, and/or any other components electrically coupled in the wearable display device 200.

As discussed above, in one example, the display frame 202 can include electrical wiring to electrically couple one securement arm 208 to a second securement arm (not illustrated) through the display frame 202. In this example, the securement port 226 can be configured to be an electrical port so as to electrically couple with the first electrical connector 228 of the hinge. In another example, the display frame 202 can be a purely mechanical frame and the illustrated securement arm 208 and a second securement arm can be communicatively coupled via wireless protocols and systems (e.g., via Bluetooth). In such an example, the hinge 206 does not necessarily include the first electrical connector 228 and the securement arm 208 does not necessarily include the second electrical connector 230. In the example with a purely mechanical frame, the hinge 206 can be a mechanical hinge coupled to the mechanical display frame 202, and the securement arm 208 can removably couple to the hinge 206.

In these examples, the securement arm 208 can be removably coupled to the hinge 206 such that the user can interchange the securement arm 208 to upgrade or replace components of the wearable display device 200 contained within the securement arm 208 without replacing the display frame 202. In this way, the user can fully customize the display frame 202 and/or include prescription lenses and not replace the display frame 202 when upgrading or fixing the wearable display device 100. In at least one example, the securement arm 208 can be removably coupled to the hinge 206 by a blind mate connector such that the securement of the securement arm 208 can be done by a user. In another example, the securement arm 208 may be interchanged by a professional worker (e.g., technical worker). In this way, a professional worker can interchange the securement arm 208 in a controlled environment. In another example, the professional worker can have specialized tools to interchange the securement arm 208 with the display frame 202 in order to ensure that removal of the securement arm is intentional and controlled.

Any of the features, components, and/or parts, of the electronic device, including the arrangements and configurations thereof shown in FIG. 2A and FIG. 2B, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2A and FIG. 2B.

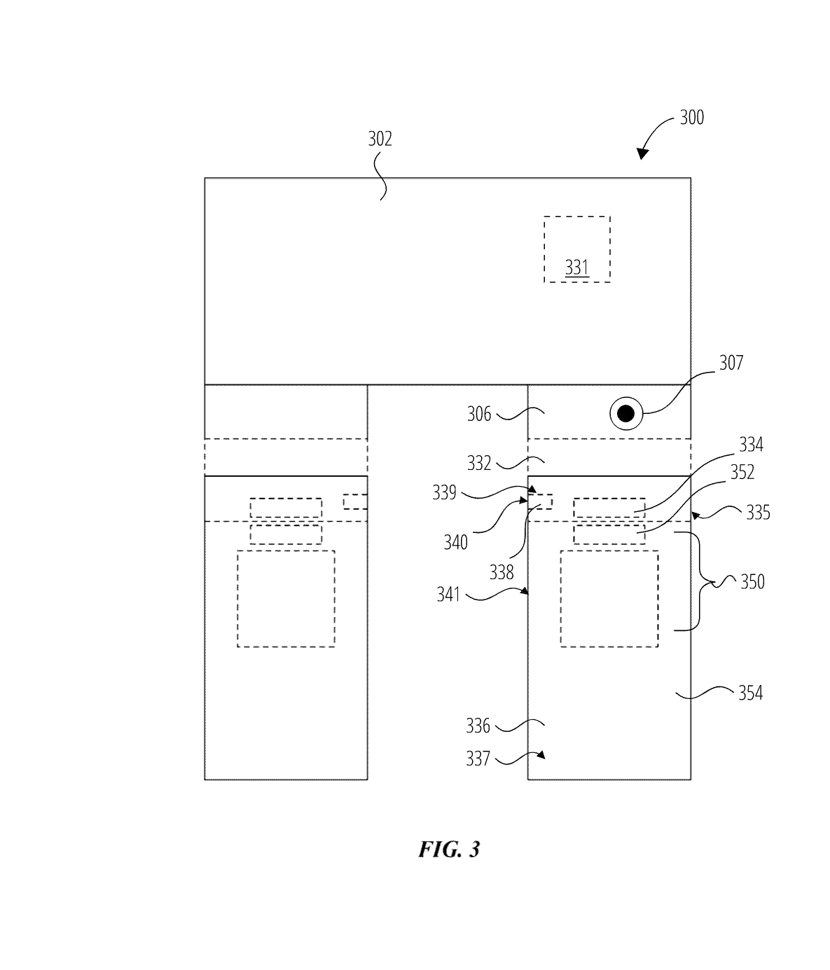

FIG. 3 illustrates a top view of one example of a wearable display device 300. The wearable display device 300 can include a display frame 302 and a hinge 306 coupled to the display frame 302. The wearable display device 300 can further include a first arm 332 movably coupled to the hinge 306 and extending from the display frame 302. In one example, the first arm 332 can be movable relative to the display frame 302 via the hinge 306. For example, the first arm 332 can be in an open position (e.g., open position to don the wearable display device 300 to the user's head), or a closed position (e.g., position for storage of the wearable display device 300). In this way, the hinge 306 can rotate the first arm 332 relative to the display frame 302 about an axis 307.

The wearable display device 300 can further include a first electrical connector 334 disposed on the distal end 335 of the first arm 332. In this example, the wearable display device 300 can include a second arm 336 defining an internal volume 337. In one example, the distal end 335 of the first arm 332 can be configured to have a smaller diameter than an internal diameter of the second arm 336 such that the second arm 336 can receive at least a portion of the first arm 332 within the internal volume 337 to removably couple the second arm to the first arm 332.

In one example, the distal end 335 of the first arm 332 can include a seal (not illustrated) disposed around the periphery of the first arm 332. The seal can be a hermetic seal or a wiper seal. According to this example, the seal can create an environmental seal between the first arm 332 and the second arm 336 during or upon assembly. In this way, the hermetic seal can stop sweat, debris, or water from entering the internal volume 337 where electrical components can be disposed. In one example, the seal between the first arm 332 and the second arm 336 can create a tight or even an interference fit to reduce movability between the portion of the received first arm 332 and the internal volume 337 of the second arm 336. In this way, the first arm 332 received by the second arm 336 can define a single seamless arm. Consequently, the aesthetics of the securement arm, such as the securement arm 108 illustrated in FIG. 1, can be increased, and the smooth transition between arms can prevent snags that could otherwise occur between the interface of the first arm 332 and the second arm 336.

In one example, the distal end 335 of the first arm 332 can define at least one aperture 339. In this example, a proximal end 341 of the second arm 336 can define at least one opening 340 that can align with the aperture 339 of the first arm 332 as the first arm 332 is received within the second arm 336. The wearable display device 300 can further include a fastener 338 that can fasten the first arm 332 to the second arm 336 through the opening 340 of the second arm 336 and into the aperture 339 of the first arm 332 when they are aligned. In one example, the fastener 338 can be a screw, a bolt, a pin, or any other suitable fastener. In this way, the second arm 336 can be mechanically secured to the first arm 332 to prevent any separation of the first arm 332 from the second arm 336.

In one example, the wearable display device 300 can further include an electrical assembly 350 disposed within the internal volume 337. The electrical assembly 350 can include a multi-layer board 354, and a second electrical connector 352 disposed proximally to the multi-layer board 354. The second electrical connector 352 can electrically couple to the first electrical connector 334. In one example, the first electrical connector 334 and the second electrical connector 352 can be pin and slot electrical connectors. In another example, the first electrical connector 334 can be configured to include spring pings and the second electrical connector 352 can be a printed circuit board (PCB) or a rigid flex to electrically couple the first and second electrical connector 334, 352. In this way, the first electrical connector 334 and the second electrical connector 352 can transfer power or both power and data. As illustrated in FIG. 3, the above-mentioned functions and components can be disposed in one or both securement arms. In some examples, the above-mentioned components and functions can be disposed in the securement arm in various combinations as discussed above or in any suitable way between the one or two securement arms.

As illustrated in FIG. 3, the wearable display device 300 can further include a camera 331 disposed within the display frame 302, according to some examples. In one example, the camera 331 can be disposed within the display frame 302 such that the camera 331 is facing away from the user. The camera 331 can be disposed in any defined area of the display frame 302. In one example, the camera 331 can be electrically coupled to the first electrical connector 334. In this way, the camera 331 can be electrically coupled to the second electrical connector 352 when the first electrical connector 334 is electrically coupled and can transfer data and/or power between all components.

Any of the features, components, and/or parts, of the electronic device, including the arrangements and configurations thereof shown in FIG. 3, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

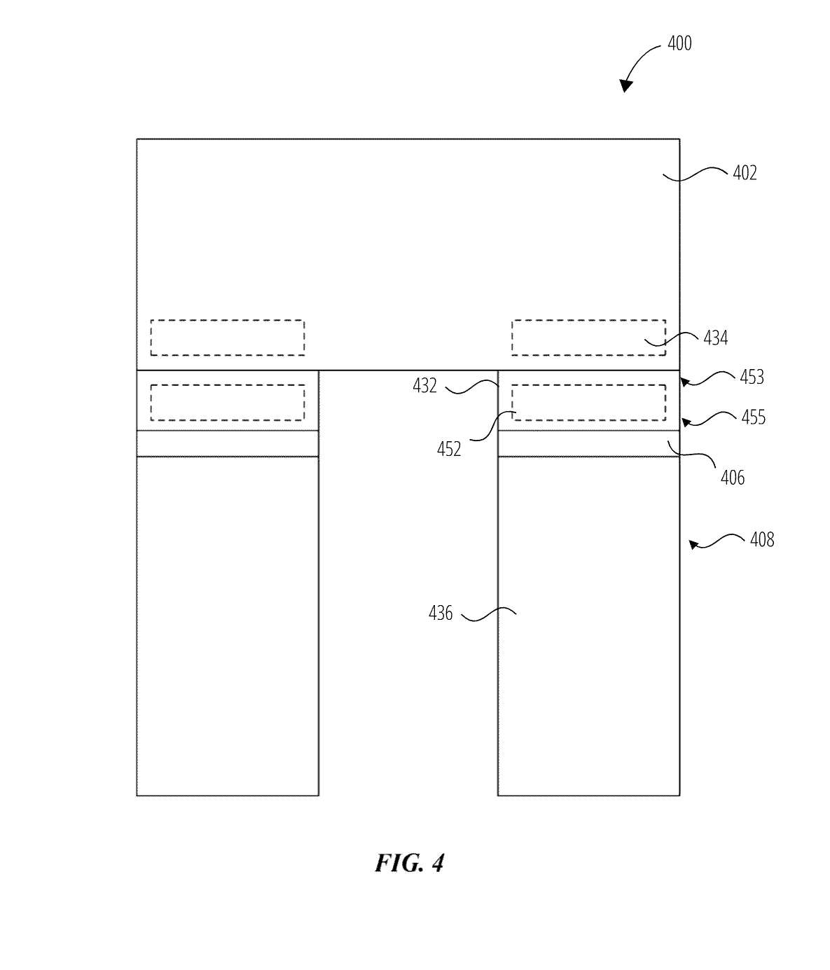

FIG. 4 illustrates a top view of one example of a wearable display device 400. In one example, the wearable display device 400 can include a display frame 402 and a first electrical connector 434 coupled to the display frame 402. The wearable display device 400 can further include a first arm 432 removably coupled to the display frame 402, and a second electrical connector 452 coupled to a proximal end 453 of the first arm 432. In one example the second electrical connector 452 can be electrically coupled to the first electrical connector 434. As discussed above, the electrical connectors discussed herein can transfer power or both power and data. In this example, a hinge 406 can be coupled to the distal end 455 of the first arm 432, and a second arm 436 can be movably couple to the first arm 432 via the hinge 406. In this way, the second arm 436 can be movable relative to the first arm 432 via the hinge 406.

As illustrated in FIG. 4, the first arm 432 and the second arm 436 can collectively define a seamless securement arm 408. For example, in an open position, the first arm 432 and the second arm 436 can define a flush or continuous surface along the length of the first arm 432 and the second arm 436. In this way, the first arm 432 and the second arm 436 that form the securement arm 408 can visually appear as a single piece to increase the aesthetic appeal of the arm. As a result of this structure, the seam created between the first arm 432 and the second arm 436 can be difficult to see. In this example, the user can removably couple the securement arm 408 to the display frame 402. This configuration also allows the user to replace the securement arm 408 when upgrading or replacing components. The changing of the securement arm 408 can include an upgraded second electrical connector 452, an upgraded hinge 406 and an upgraded first arm 432 and second arm 436 by replacing a single securement arm 408. In this example, the user can retain a customized display frame 402 that can include prescription lenses and upgrade components of the wearable display device 400 by only interchanging the securement arm 408. Additionally, the interchangeability of the securement arm 408 can decrease the amount of electrical waste when upgrading the wearable display device 400 by eliminating the waste of the entire system.

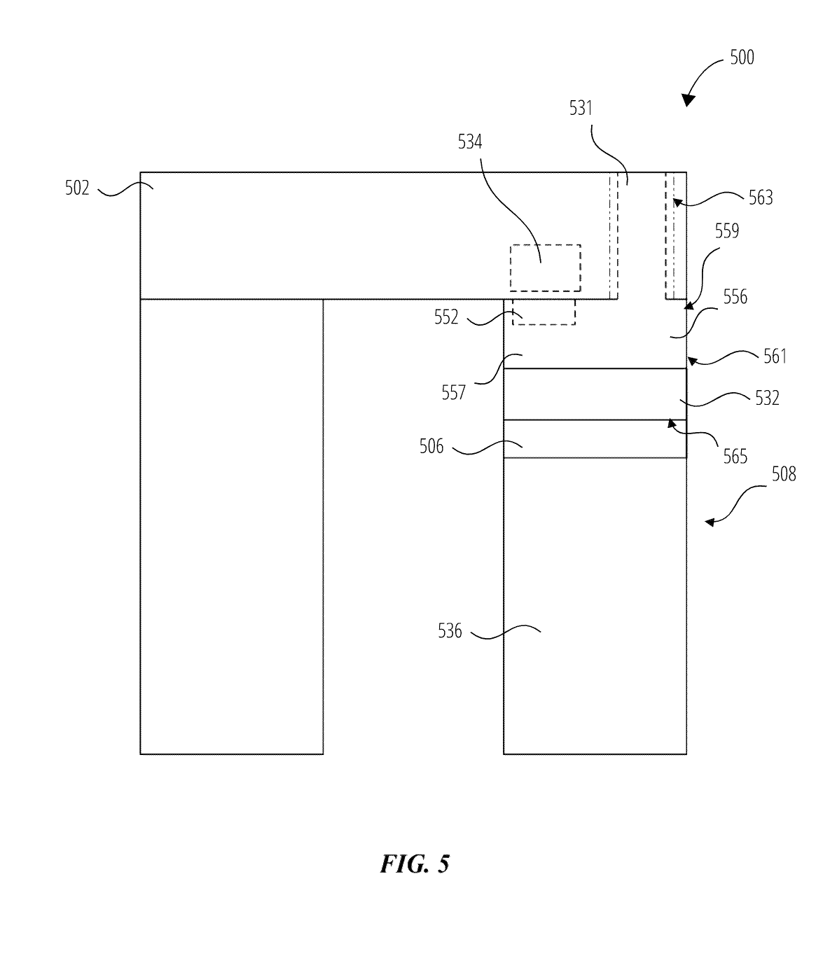

In one example, the second electrical connector 452 can define a housing coupled to the proximal end 453 of the first arm 432 (as illustrated in FIG. 5). As discussed in more detail below, the wearable display device 400 can further include a camera disposed in the housing and the display frame 402 can define an aperture such that the camera can extend from the first arm 432 through the aperture. In this example, the camera can be electrically coupled to the second electrical connector 452.

Any of the features, components, and/or parts, of the electronic device, including the arrangements and configurations thereof shown in FIG. 4, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4.

FIG. 5 illustrates a top view of one example of a wearable display device 500. The wearable display device 500 can include a display frame 502 that can define a pass-through aperture 563, a first electrical connector 534 coupled to the display frame 502, and an electrical connector assembly 556. The electrical connector assembly 556 can include a housing 557. The housing 557 can include a proximal end 559 removably coupled to the display frame and a distal end 561. The electrical connector assembly 556 can further include a second electrical connector 552 disposed on the proximal end 559 of the housing 557 such that the second electrical connector 552 can electrically couple to the first electrical connector 534. As discussed above, the first electrical connector 534 and the second electrical connector 552 can be electrically coupled such that power and/or data can be transferred therebetween. In one example, the second electrical connector 552 can electrically couple to the first electrical connector 534 via a blind mate electrical connection. In this way, the blind mate electrical connection can enable the user to engage and disengage the first electrical connector 534 and the second electrical connector 552 without the assistance of a professional (e.g., technical worker).

As illustrated in FIG. 5, the second electrical connector 552 can include a camera 531 coupled to the housing 557 such that the camera 531 can be disposed within the pass-through aperture 563 defined by the display frame 502. In this example, the camera 531 can be a part of a securement arm 508 such that the camera 531 can be interchanged and upgraded by the user, as the user interchanges the securement arm 508. In this way, the camera 531 can be upgraded or replaced by the user along with other components in the securement arm 508 without the user having to replace the display frame 502. As illustrated in FIG. 5, the camera 531 can extend through the pass-through aperture 563 of the display frame 502 to face away from the user. Although FIG. 5 illustrates the camera 531 disposed in the right portion of the display frame 502, it should be understood that camera 531 can be disposed in any position and/or orientation about the display frame 502.

In one example, the wearable display device 500 can further include a first arm 532 coupled to the distal end 561 of the housing 557. The wearable display device 500 can further include a hinge 506 coupled to a distal end 565 of the first arm 532, and a second arm 536 movably coupled to the first arm 532 via the hinge 506. In this way, the second arm 536 can rotate relative to the first arm 532 and the display frame 502 via the hinge 506 about an axis, (such as the axis 307 illustrated in FIG. 3). The camera 531 can be housed on the proximal end of the housing 557 and can be disposed within the pass-through aperture 563 to be distanced away from the hinge 506. In this way, the camera 531 can remain in a fixed position within the pass-through aperture 563 of the display frame 502 while the second arm 536 can rotate relative to the first arm 532. Furthermore, the hinge 506 being separate from the electrical connector 552 and the camera 531 can protect electronic components as the hinge 506 rotates the second arm 536 about the first arm 532.

Any of the features, components, and/or parts, of the electronic device, including the arrangements and configurations thereof shown in FIG. 5, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user’s general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to "opt in" or "opt out" of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A wearable display device, comprising:
a display frame;
a hinge coupled to the display frame;
a first arm movably coupled to the hinge and extending distally from the display frame, the first arm movable relative to the display frame via the hinge;
a first electrical connector disposed on a distal end of the first arm;
a second arm defining an internal volume, the second arm configured to receive the first arm in the internal volume to removably couple to the first arm; and
an electrical connector assembly disposed within the internal volume, the electrical connector assembly comprising:
a multi-layer board (MLB); and
a second electrical connector disposed proximal to the MLB, the second electrical connector configured to electrically couple with the first electrical connector when the first arm is received in the internal volume.

2. The wearable display device of claim 1, wherein the hinge is configured to rotate the first arm relative to the display frame about an axis.

3. The wearable display device of claim 1, wherein the first arm is configured to be received by the second arm to form a seamless arm.

4. The wearable display device of claim 1, wherein the first arm comprises a seal disposed around the distal end of the first arm.

5. The wearable display device of claim 4, wherein the seal comprises a hermetic seal.

6. The wearable display device of claim 1, wherein the distal end of the first arm defines an aperture.

7. The wearable display device of claim 6, wherein a proximal end of the second arm defines an opening aligned with the aperture when the second arm is secured to the first arm.

8. The wearable display device of claim 7, further comprising a fastener disposed through the opening of the second arm and the aperture of the first arm to secure the first arm to the second arm.

9. The wearable display device of claim 8, wherein the display frame defines a pass-through aperture.

10. The wearable display device of claim 1, further comprising a camera disposed within the display frame.

11. The wearable display device of claim 10, wherein the camera is electrically coupled to the first electrical connector.

12. The wearable display device of claim 1, wherein the first electrical connector and the second electrical connector include at least one of a pin electrical connector or a slot electrical connector.

13. A head-mountable display, comprising:
a display frame;
a first electrical connector coupled to the display frame;
a first arm removably coupled to the display frame and extending distally from the display frame;
a second electrical connector coupled to a distal end of the first arm, the second electrical connector electrically coupled to the first electrical connector;
a hinge coupled to the distal end of the first arm; and
a second arm coupled to the first arm via the hinge, the second arm movable relative to the first arm via the hinge.

14. The head-mountable display of claim 13, wherein the second electrical connector further comprises a housing coupled to the distal end of the first arm.

15. The head-mountable display of claim 14, further comprising a camera coupled to the housing.

16. The head-mountable display of claim 15, wherein:
the display frame defines an aperture; and
the camera extends through the aperture.

17. The head-mountable display of claim 16, wherein the camera is electrically coupled to the second electrical connector.

18. A wearable electronic device, comprising:
a display frame defining an aperture;
a first electrical connector coupled to the display frame;
an electrical connector assembly, comprising:
a housing including a proximal end removably coupled to the display frame, and a distal end; and
a second electrical connector disposed at the proximal end, the second electrical connector electrically coupled to the first electrical connector;
a camera coupled to the housing and disposed within the aperture;
a first arm coupled to the distal end of the housing;
a hinge coupled to a distal end of the first arm; and
a second arm movably coupled to the first arm via the hinge.

19. The wearable electronic device of claim 18, wherein the second arm is movable relative to the first arm about an axis via the hinge.

20. The wearable electronic device of claim 18, wherein the second electrical connector is electrically coupled to the first electrical connector via a blind mate electrical connection.
